(19) United States
(12) Patent Application Publication
(10) Pub. No.: US 2003/0126346 A1
(43) Pub. Date: Jul. 3, 2003

(54) Dynamic load balancing in a multi-bus computer system

(76) Inventor: Sung H. Kuo, Houston, TX (US)

Correspondence Address: AKIN, GUMP, STRAUSS, HAUER & FELD, 711 LOUISIANA STREET, SUITE 1900 SOUTH, HOUSTON, TX, 77002, US

(21) Appl. No.: 10/039,020

(22) Filed: Dec. 31, 2001

(51) Int. Cl. G06F 13/00

(52) U.S. Cl. 710/311; 710/301; 710/104; 710/307

(57) ABSTRACT

A multi-bus computer system is adapted for dynamic load balancing. The computer system includes a plurality of expansion slots, a first expansion bus, a second expansion bus, and a bus switching mechanism to assign at least one of the plurality of expansion slots between the first expansion bus and the second expansion bus. Selection of the particular expansion bus may be controlled by a bus selection signal based on a type of device in the particular expansion slot, the speed of the device in the expansion slot, the bitsize of the device in the expansion slot, or availability of each expansion slot.

### CROSS-REFERENCE TO RELATED APPLICATIONS

Not applicable.

### STATEMENTS REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

1. Field of the Invention

The present invention generally relates to multi-bus computer systems and more particularly to dynamic load balancing in such systems.

2. Description of the Related Art

Most computer systems today utilize Peripheral Component Interconnect (PCI) buses as the input/output (I/O) expansion bus on which system I/O components reside. These components may include Small Computer System Interface (SCSI) controllers, network interface cards and video cards. In high performance systems such as high-end workstations or servers, there typically exist multiple PCI buses arranged in a peer bus architecture that provides the maximum number of paths directly into the memory and processors. This generally allows the highest level of concurrent access to required data and allows the best data throughput and performance. In today's system, there are several types of PCI buses and PCI-X buses available: 32-bit 33 MHz PCI, 64-bit 33 MHz PCI, 64-bit 66 MHz PCI, 100 MHz PCI-X, 133 MHz PCI-X and other types of I/O buses.

Due to the limitation of mechanical space available in a chassis of a computer system and other related factors, a system designer will have to decide on how many slots will be provided in the system and what types of slots to provide. Since different types of slots typically reside on different types of I/O buses, the system designer will have to make assumptions as to what types of cards a user will typically install in these slots. For example, the designer may have to decide whether to provide 32-bit PCI slots and/or 64-bit PCI slots and how many slots of each if both slot types are supported. Unfortunately, users tend to have different needs from computer systems. As a result, it is possible that the designer made a wrong choice in what type of slot mix to provide. In that circumstance, a user is not afforded the maximum data transfer potential of the cards. For example, the user might be forced to place a 64-bit PCI card into a 32-bit PCI slot, resulting in half the data transfer rate than if the 64-bit PCI card were in a 64-bit PCI slot. The user also may unknowingly be wasting bandwidth by heavily loading one expansion bus while another expansion bus is idle. For example, in a dual-bus computer system with three 32-bit PCI cards in 32-bit PCI slots and three 64-bit PCI cards in 64-bit PCI slots, if all three 64-bit PCI cards are assigned to one expansion bus, then a certain amount of bandwidth of the other expansion bus is being wasted.

Another reason for performance degradation is the sharing of buses by different cards. For example, if a user was unaware of the bus type of the slots and inserted a 33 MHz PCI card and a 66 MHz PCI card into the slots of the same expansion bus, the entire expansion bus will be running at the slower 33 MHz speed. This reduced the performance of 66 MHz PCI cards by half. Although the current PCI standard allows backward compatibility of faster buses to accommodate the lower speeds (For example, 133 MHz 64 bits PCIX bus will support 33 MHz 32 bit PCI cards), it will not negotiate to each device individually. This is another reason where this invention can be important.

### BRIEF SUMMARY OF THE INVENTION

A multi-bus computer system is adapted for dynamic load balancing. The computer system includes a plurality of expansion slots, a first expansion bus, a second expansion bus, and a bus switching mechanism to assign at least one of the plurality of expansion slots between the first expansion bus and the second expansion bus. Selection of the particular expansion bus may be controlled by a bus selection signal based on a type of device in the particular expansion slot, the speed of the device in the expansion slot, the bitsize of the device in the expansion slot, or availability of each expansion slot.

### BRIEF DESCRIPTION OF THE SEVERAL VIEWS OF THE DRAWINGS

A better understanding of the present invention can be obtained when the following detailed description is considered in conjunction with the following drawings, in which:

FIG. 1 is a block diagram of an exemplary computer system adapted for bus switching between a 32-bit PCI bus and a 64-bit PCI bus;

FIG. 2 is a block diagram illustrating exemplary switch logic and signaling for dynamic assignment between the 32-bit PCI bus and the 64-bit PCI bus of FIG. 1 to a 64 bit PCI slot;

FIG. 3 is a truth table for the switch logic of FIG. 2;

FIG. 4 is a block diagram of an exemplary computer system adapted for bus switching between a 32-bit PCI bus and a 64-bit PCI bus utilizing system firmware;

FIG. 5 is a flowchart of an exemplary firmware process for dynamically optimizing bus loading for a multi-bus computer system such as shown in FIG. 4;

FIG. 6 is an illustration in table form of exemplary stages associated with the firmware process of FIG. 5;

FIG. 7 is a block diagram illustrating exemplary switch logic and signaling for dynamic assignment between two 64-bit PCI buses to a 64-bit 5V PCI slot;

FIG. 8 is a diagram of an exemplary architecture for dynamic switching among three PCI buses to PCI expansion slots of a computer system; and

FIG. 9 is an illustration of an exemplary multiplexor architecture for dynamically switching among three PCI buses to PCI expansion slots of a computer system.

### DETAILED DESCRIPTION OF THE INVENTION

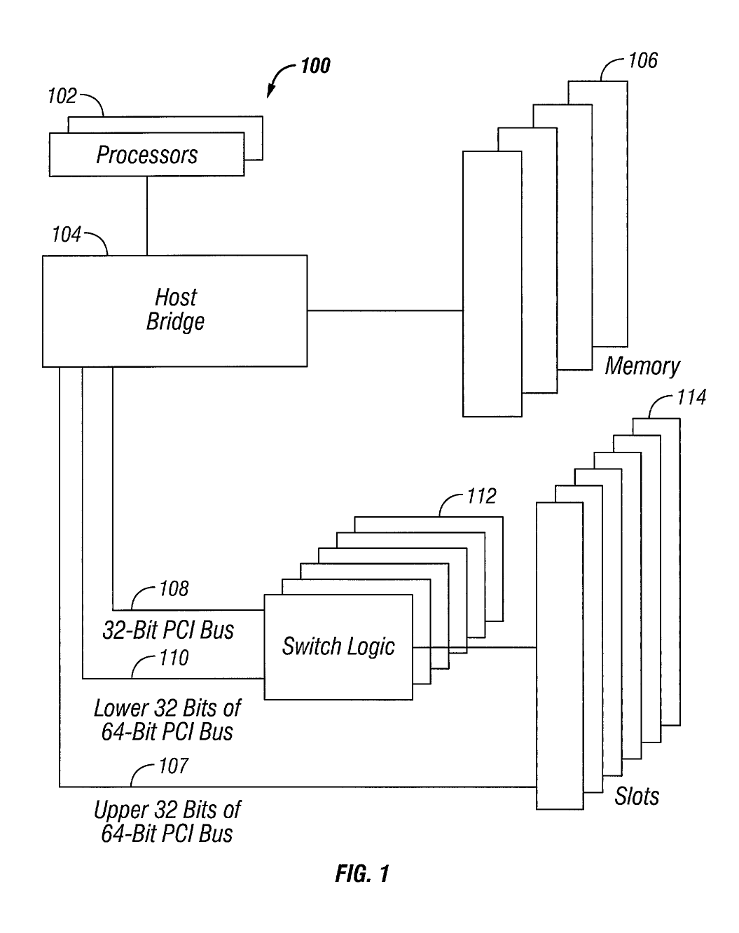

Turning now to the drawings, FIG. 1 shows an exemplary computer system 100 adapted for bus switching between a 32-bit Peripheral Component Interconnect (PCI) bus 108 and a 64-bit PCI bus 107 and 110. Through a host bridge 104, processors 102 are coupled to memories 106 and PCI buses 107, 108 and 110. While the upper 64 bits of the 64-bit PCI bus 107 is coupled directly to the PCI slots 114, the 32-bit PCI bus 108 and the lower 32 bits of the 64-bit PCI bus 110 are selectively coupled to the PCI slots 114 through switch logic 112. A particular slot thus may be assigned to either the 32-bit PCI bus 108 or the 64-bit PCI bus 107 and 110. In this configuration, the PCI buses 107, 108 and 110 serve as expansion buses, and the slots 114 serve as expansion slots.

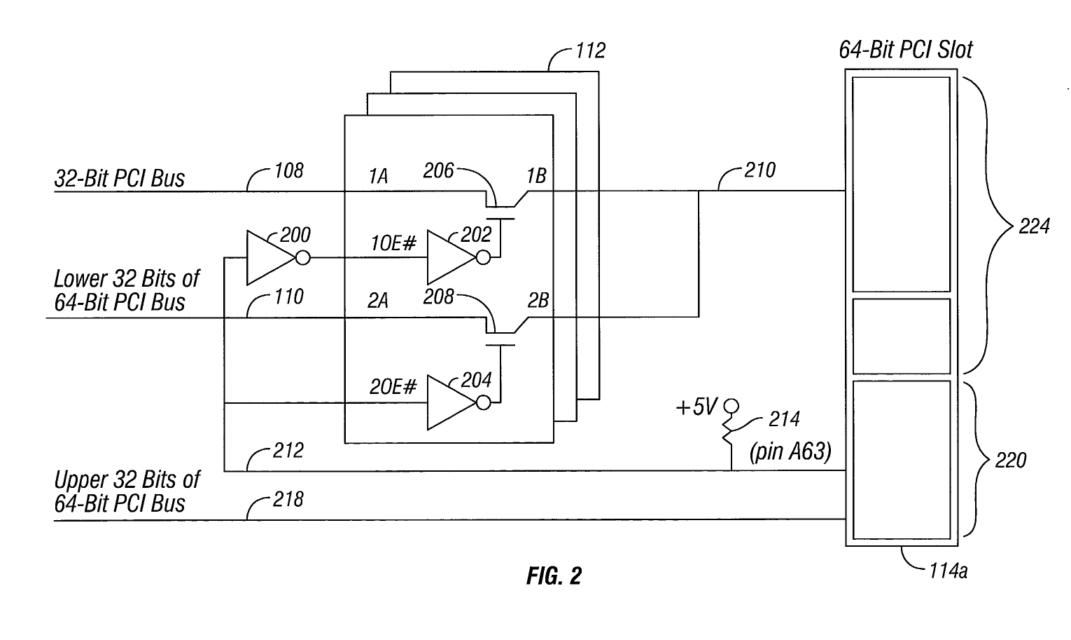

Referring to FIG. 2, exemplary switch logic and signaling for dynamic assignment between the 32-bit PCI bus 108 and the lower 32 bits of the 64-bit PCI bus 110 to a 64-bit PCI slot 114a is shown. Either the 32-bit PCI bus 108 or the lower 32 bits of the 64-bit PCI bus 110 can be connected to the 64-bit PCI slot 114a. A portion 224 of the 64-bit PCI slot 114a is a common interface for either the 32-bit PCI bus 108 or the lower 32 bits of the 64-bit PCI bus 110, and a portion 220 of the 64-bit PCI slot 114a is only used by the upper 32 bits of the 64-bit PCI bus. The 64-bit PCI slot 114a is automatically assigned to the appropriate bus depending on the type of PCI card detected in the slot 114a. If a 64-bit PCI card is detected in the slot 114a, then the lower 32 bits of the 64-bit PCI bus 110 is assigned to the slot 114a. If a 32-bit PCI card is detected in the slot 114a, then the 32-bit PCI bus 108 is assigned to the slot 114a. The 64-bit PCI bus 218 is shown to represent the upper 32 bits of the 64-bit PCI slot 114a that may be connected to the 64-bit PCI bus because the 32-bit PCI bus does not use this portion of the slot.

In this embodiment, the switch logic 112 coupled to the 32-bit PCI bus 108 and the lower 32 bits of the 64-bit PCI bus 110 is implemented as a bus switch. The bus switch 112 may be placed as close to the 64-bit PCI slot 114a as possible. An example of a suitable bus switch is a PI5C116210 20-bit, 2-port bus switch available from Pericom Semiconductor. The bus switch 112 is shown in the form of a logic block diagram. The 32-bit PCI bus 108 serves as the input signal 1A to the source of a transistor 206. The lower 32 bits of the 64-bit PCI bus 110 is negated by an inverter 200 with the negated signal serving as a bus enable input 1OE# provided to an inverter 202. The output of the inverter 202 is provided as a control signal to the gate of the transistor 206. The 64-bit PCI bus 110 also serves as an input signal 2A to the source of a transistor 208 and as a bus enable input 2OE# negated by an inverter 204. The negated signal serves as a control signal to the gate of the transistor 208. Either an output signal 1B from the drain of the transistor 206 or an output signal 2B from the drain of the transistor 208 are provided to the PCI slot 114a depending upon the states of the transistors 206 and 208.

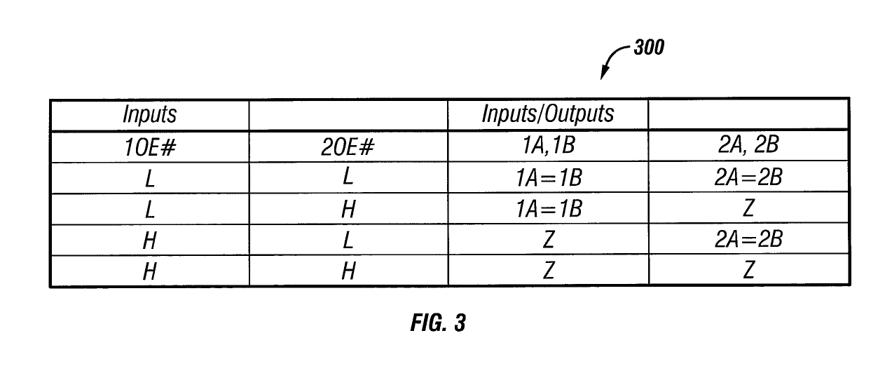

Turning to FIG. 3, a truth table 300 corresponding to the logic block diagram of the bus switch 112 in FIG. 2 is shown. The portions of the truth table 300 applicable to the logic block diagram in FIG. 2 are the condition where the bus enable input 1OE# is low and the bus enable input 2OE# is high and the condition where the bus enable input 1OE# is high and the bus enable input 2OE# is low. If a 64-bit PCI card is plugged into the 64-bit PCI slot 114a, then pin A63 is grounded on the card, driving the signal 212 low. The signal 212 serves as a presence detect signal capable of detecting the presence of a 64-bit PCI card in the 64-bit PCI slot 114a. Since the signal 212 is low, the input to the inverter 200 is low and the bus enable input 1OE# is high. Since the signal 212 serves as the bus enable input 2OE#, the bus enable input 2OE# is low. According to the truth table 300, the input signal 1A and the output signal 1B are placed in a high Z or impedance state, and the output signal 2B is set to the input signal 2A. Consequently, the 32-bit PCI bus 108 is electrically isolated from the 64-bit PCI slot 114a and the lower 32 bits of the 64-bit PCI bus 110 are electrically connected to the 64-bit PCI slot 114a.

If a 32-bit PCI card is plugged into the 64-bit PCI slot 114a, then the A63 pin is pulled up by a pull-up resistor 214, driving the signal 212 high. Since the signal 212 is high, the bus enable input 2OE# is high and the bus enable signal 1OE# is low. According to the truth table 300, the input signal 2A and the output signal 2B are placed in a high Z or impedance state, and the output signal 1B is set to the input signal 1A. Consequently, the lower 32 bits of the 64-bit PCI bus 110 are electrically isolated from the 64-bit PCI slot 114a and the 32-bit PCI bus 108 is electrically connected to the 64-bit PCI slot 114a. A number of similar logical configurations to that represented in FIGS. 2 and 3 may alternatively be used to implement the bus switch 112.

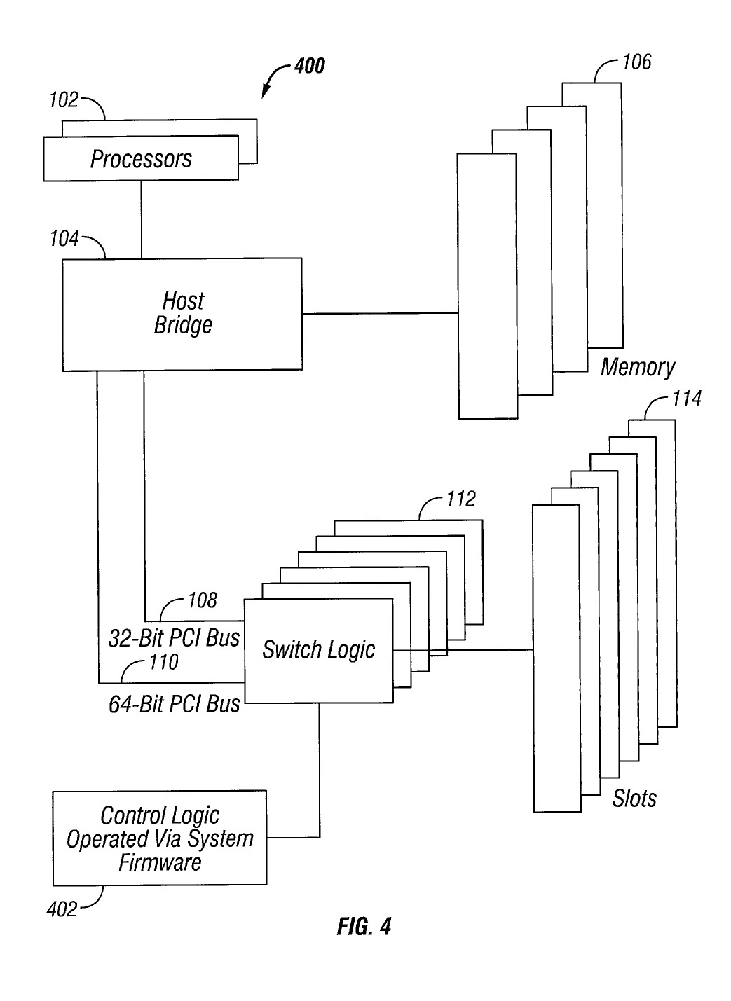

Referring to FIG. 4, an exemplary computer system 400 adapted for bus switching between the 32-bit PCI bus 108 and the lower 32 bits of the 64-bit PCI bus 110 utilizing system firmware is shown. As opposed to basing bus switching strictly upon a presence detect signal such as described in connection with FIG. 2, bus switching in FIG. 4 is based on logic under system firmware control. Control logic 402 enables system firmware to control the switch logic 112. Unlike the switch logic 112 in FIG. 2, the switch logic 112 in FIG. 4 is software controlled. A software-based approach to dynamic bus switching presents a great amount of flexibility in balancing load in a multi-bus computer system. For example, depending on the number and type of cards in the computer system 100, firmware may dynamically identify and establish a bus assignment to balance the load. With the techniques disclosed herein, maximum throughput to each available bus may be accomplished.

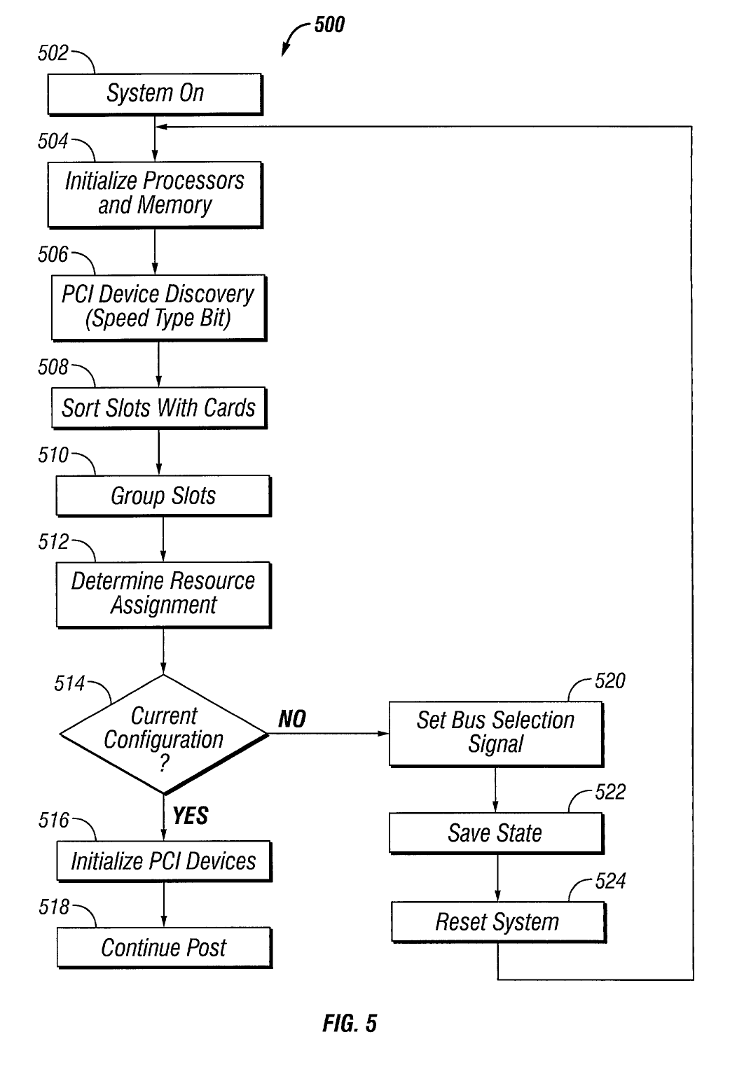

Referring to FIG. 5, an exemplary firmware process for dynamically optimizing bus loading for a multi-bus computer system such as illustrated in FIG. 4 is shown. Beginning in step 502, system power is turned on. Next, in step 504, the processors and memories in the computer system are initialized. Control then proceeds to step 506 where PCI device discovery is performed. In this step, every PCI card in a slot is identified by speed, type and bitsize. As to speed, it may determined whether the card is a 33 MHz, 66 MHz, 100 MHz, or 133 MHz card. Regarding type, it may be determined if the card is a PCI-card or a PCI-X card. The type of card must match the corresponding type of bus. As to bitsize, it may be determined if the card is a 32-bit card or a 64-bit card.

In step 508, the cards identified in step 506 are sorted by slot. In other words, the firmware takes account of which particular cards are found in which particular slots. From step 508, the process proceeds to step 510 where slots are grouped by common characteristics. Slots containing cards of the same speed, type and bitsize are placed in the same group. Any cards of different speed, type or bitsize are placed in different groups. The next step in the process is to determine an assignment of resources in step 512. In this step, a bus or group of buses to assign to each group of cards is determined. Next, in step 514, the firmware determines if the determined resource assignment matches the current configuration. If there is a match, the process proceeds to step 516 in which the PCI cards are initialized. Following step 516, Power On Self Test (POST) code continues to execute.

If the determined resource assignment does not match the current configuration in step 514, then the process proceeds to step 520 where the bus selection signal is set to dynamically assign the buses based on the determined resource assignment. This determined resource assignment represents a more optimized bus configuration than the current bus configuration. The state of the bus selection signal is saved in step 522. Next, in step 524, the computer system is reset to guarantee that the state of the bus selection signal is correct. From step 524, the process returns to step 504. At this point, the state of the bus selection signal is read and governs the current resource assignment until the next dynamic resource assignment.

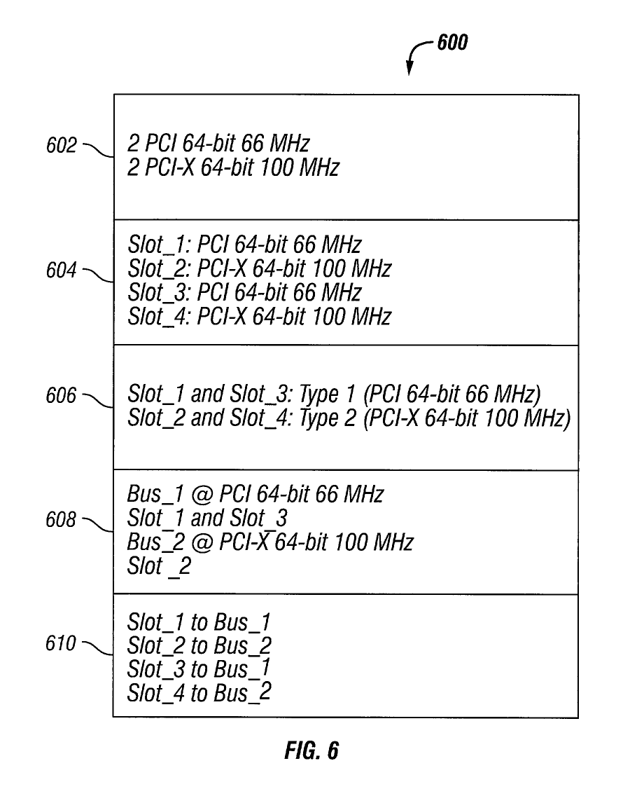

Referring to FIG. 6, an illustration in table form of exemplary stages associated with the firmware process of FIG. 5 is shown. Step 602 corresponds to step 506 of FIG. 5. In this example, two PCI 64-bit 66 MHz cards and two PCI-X 64-bit 100 MHz cards are identified during PCI device discovery. Stage 604 corresponds to step 508 of FIG. 5. Slot_1 is identified as containing a PCI 64-bit 66 MHz card; Slot_2 is identified as containing a PCI-X 64-bit 100 MHz card; Slot_3 is identified as containing a PCI 64-bit 66 MHz card; and Slot_4 is identified as containing a PCI-X 64-bit 100 MHz card. Stage 606 corresponds to step 510 of FIG. 5. Slot_1 and Slot_3 are grouped as containing PCI 64-bit 66 MHz cards (Type 1). Slot_2 and Slot_4 are grouped as containing PCI-X 64-bit 100 MHz cards (Type 2). Stage 608 corresponds to step 512 of FIG. 5. In this example, the optimal resource assignment is to assign Bus_1 to Slot_1 and Slot_3 and to assign Bus_2 to Slot_2 and Slot_4. Stage 610 corresponds to step 520 of FIG. 5. The bus selection signal sets Slot_1 to Bus_1, Slot_2 to Bus 2, Slot_3 to Bus_1, and Slot_4 to Bus_2.

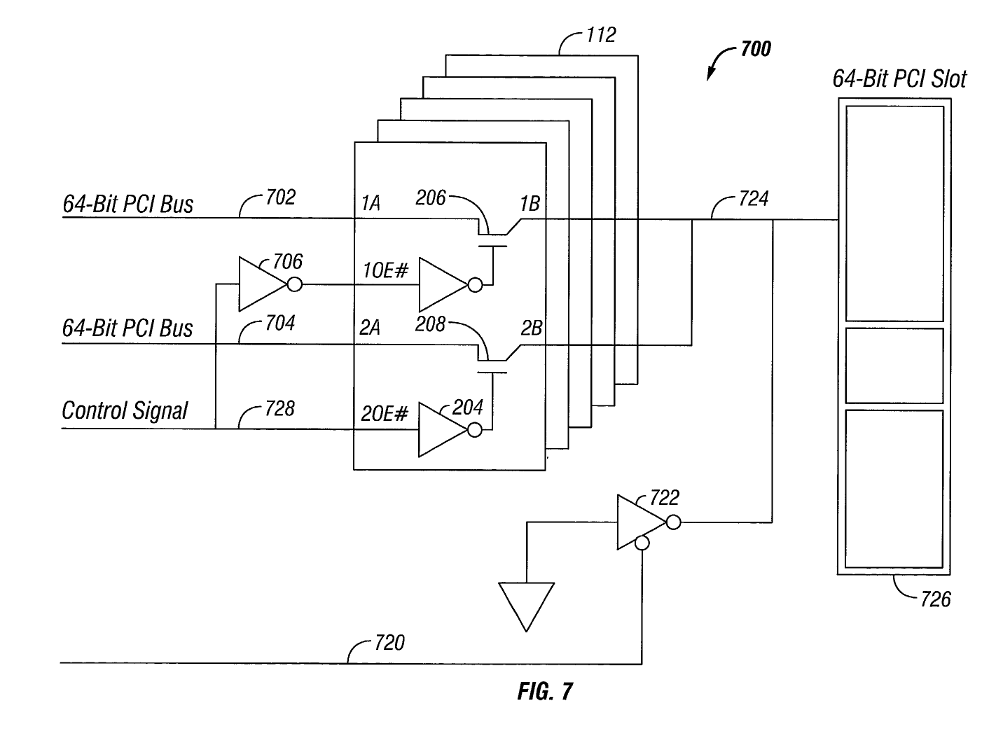

Referring to FIG. 7, exemplary switch logic and signaling for dynamic assignment between a 64-bit PCI bus 702 and a 64-bit PCI bus 704 to a 64-bit PCI slot 726 is shown. A software programmable signal 728 is utilized in connection with a bus switch 112 to control bus switching for the 64-bit PCI buses 702 and 704. A suitable example of a software programmable signal is a general purpose input/output (GPIO) signal. The bits of the GPIO signal may be set by firmware. If the software programmable signal 728 is high, then the bus enable signal 2OE# is high and the bus enable signal 1OE# is low. By virtue of the inverter 706, the buses enable signal 1OE# is an inverted version of the software programmable signal 728. According to the truth table 300, the input signal 2A and the output signal 2B are placed in a high Z or impedance state, and the output signal 1B is set to the input signal 1A. Consequently, the 64-bit PCI bus 704 is electrically isolated from the 64-bit PCI slot 726 and the 64-bit PCI bus 702 is electrically connected to the 64-bit PCI slot 726.

If the software programmable signal 728 is low, then the bus enable signal 2OE# is low and the bus enable signal 1OE# is high. According to the truth table 300, the input signal 1A and the output signal 1B are placed in a high Z or impedance state, and the output signal 2B is set to the input signal 2A. Consequently, the 64-bit PCI bus 702 is electrically isolated from the 64-bit PCI slot 726, and the 64-bit PCI bus 704 is electrically connected to the 64-bit PCI slot 726. The software programmable signal 728 thus serves as a load-based bus selection signal. While only one PCI slot is shown in FIG. 7, it should be understood that the same technique may be utilized to place each slot in a computer system into the appropriate bus.

A GPIO signal 720 is coupled to an inverter 722 that connects to the 64-bit PCI slot 726 and an output line 724 from the bus switch 112. The GPIO signal 720 holds any PCI cards in the 64-bit PCI slot 726 in reset until the bus selection by the bus switch 112 is completed. In this way, the cards are prevented from accidentally driving either bus. It should be understood that the techniques disclosed may extend to buses in a computer system other than PCI buses, such as memory buses, PCI-X buses and Small Computer System Interface (SCSI) buses, for example.

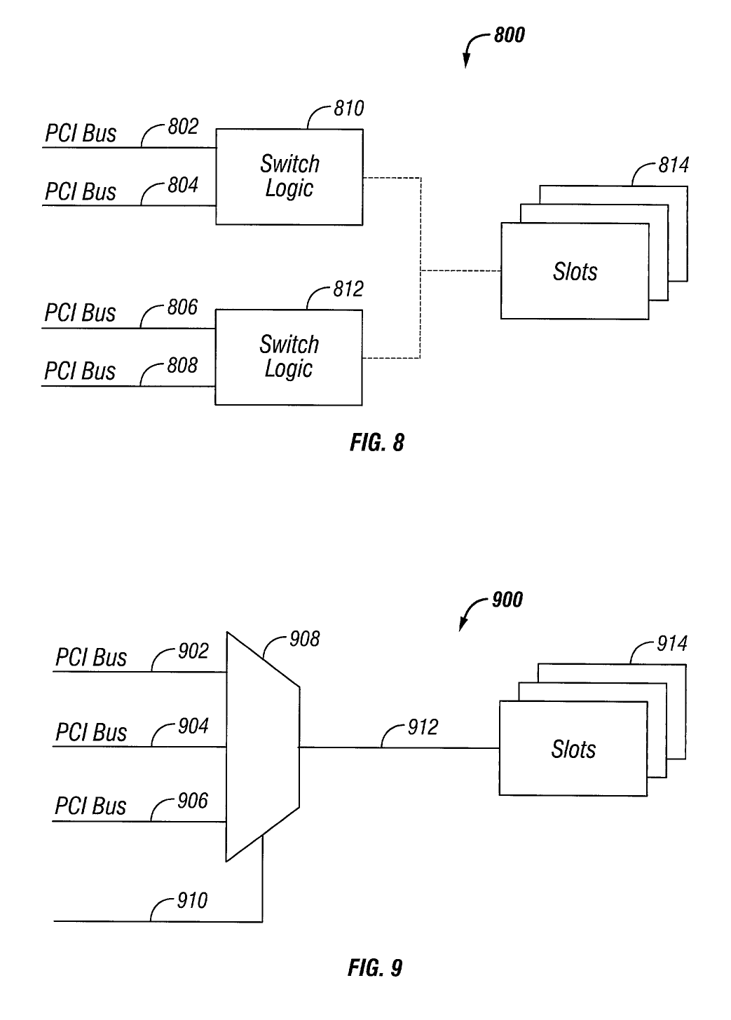

Referring to FIG. 8, an exemplary architecture for dynamic switching among four PCI buses to expansion slots of a computer system is shown. The architecture 800 includes four PCI buses 802, 804, 806 and 808. Switch logic 810 handles switching between PCI bus 802 and 804 to PCI slots 814; switch logic 812 handles switching between PCI buses 806 and 808 to PCI slots 814; Control signals to the switch logic will take account of bus connections and ensure only one bus is connected to PCI Slots 814. FIG. 8 thus helps to show that bus switching in accordance with the disclosed techniques may extend to any number of buses.

Referring to FIG. 9, an exemplary multiplexor architecture for dynamically switching among three PCI buses to expansion slots of a computer system is shown. As opposed to a bus switch, the architecture uses a multiplexor 908 to handle switching among PCI buses 902-906. Based on the particular PCI bus selected by the control signal 910, the multiplexor 908 generates an output signal 912 corresponding to the selected PCI bus. As shown, the output signal 912 is provided to PCI slots 914. The control signal 910 may be a presence detect signal such as described in connection with FIG. 2 and/or a software programmable bus selection signal such as described in connection with FIG. 7. Based on FIG. 9, it should be understood that the multiplexor 908 may be used as an alternative to bus switch 112 in FIGS. 2 and 7 as long as the timing requirements are met.

I claim:

1. A computer system, comprising:
a processor;
a bridge coupled to the processor;
a first expansion bus coupled to the bridge;
a second expansion bus coupled to the bridge;
a plurality of expansion slots; and
a bus switching mechanism to assign at least one of the plurality of expansion slots between the first expansion bus and the second expansion bus.

2. The system of claim 1, wherein the bus switching mechanism dynamically assigns at least one of the plurality of expansion slots based on a number of available expansion slots.

3. The system of claim 1, wherein the bus switching mechanism dynamically assigns at least one of the plurality of expansion slots based on a type of a device in at least one of the plurality of expansion slots.

4. The system of claim 1, an expansion slot of the plurality of expansion slots, comprising:
a presence detect pin to detect a type of a device in the expansion slot and to provide a bus selection signal to the bus switching mechanism to indicate a type of bus between the first expansion bus and the second expansion bus to connect with the expansion slot, the type of expansion bus matching the type of the device.

5. The system of claim 4, wherein the expansion slot fits a first device type and a second device type.

6. The system of claim 4, wherein the bus switching mechanism dynamically assigns at least one of the plurality of expansion slots based on a software programmable bus selection signal.

7. The system of claim 6, wherein the software programmable bus selection signal comprises a general purpose input/output signal.

8. The system of claim 1, wherein the first expansion bus and the second expansion bus comprise buses of a different bit size.

9. The system of claim 1, wherein the first expansion bus and the second expansion bus comprise buses of a same bit size.

10. The system of claim 1, wherein the first expansion bus and the second expansion bus comprise buses of a different type.

11. The system of claim 1, wherein the first expansion bus and the second expansion bus comprise buses of a different speed.

12. The system of claim 1, wherein the first expansion bus and the second expansion bus comprise buses of a same type.

13. The system of claim 1, wherein the first expansion bus and the second expansion bus comprise buses of a same speed.

14. The system of claim 1, wherein the bus switching mechanism comprises a bus switch.

15. The system of claim 1, wherein the bus switching mechanism comprises a multiplexor.

16. A method of dynamic load balancing in a computer system including a plurality of expansion slots and a plurality of expansion buses, the plurality of expansion buses including a first expansion bus and a second expansion bus, the method comprising the steps of:
generating a bus selection signal; and
switching electrical connection of an expansion slot of the plurality of expansion slots from the first expansion bus to the second expansion bus corresponding to the bus selection signal.

17. The method of claim 16, wherein the bus selection signal is software programmable.

18. The method of claim 16, wherein the bus selection signal comprises a presence detect signal to detect a type of a device in the expansion slot.

19. The method of claim 16, wherein the bus selection signal comprises a presence detect signal to detect a bit size of a device in the expansion slot.

20. The method of claim 16, wherein the bus selection signal is based on a plurality of presence detect signals to detect availability of each expansion slot of the plurality of expansion slots.

21. The method of claim 16, wherein the first expansion bus comprises a Peripheral Component Interconnect (PCI) bus.

22. The method of claim 16, wherein the bus selection signal is based on a load of the plurality of expansion buses.

23. The method of claim 16, further comprising the step of:
holding a plurality of devices in the plurality of expansion slots in a reset state until the switching step is complete.

24. The method of claim 16, further comprising the step of:
isolating the first expansion bus from the expansion slot.

25. The method of claim 16, wherein the expansion slot comprises a Peripheral Component Interconnect (PCI) slot.

26. The method of claim 16, wherein the first expansion bus comprises a Peripheral Component Interconnect X (PCI-X) bus.

27. The method of claim 16, further comprising the step of:
resetting the computer system after the switching step.

28. The method of claim 16, wherein the bus selection signal comprises a presence detect signal to detect a speed of a device in the expansion slot.
